(19) United States
(12) Patent Application Publication
(10) Pub. No.: US 2026/0185626 A1
(43) Pub. Date: Jul. 2, 2026

(54) VALVE FOR AN AIRCRAFT TURBINE ENGINE

(71) Applicant: SAFRAN AIRCRAFT ENGINES, Paris (FR)

(72) Inventors: Kevin Didier Pierre LE NORMAND, Moissy-Cramayel (FR); Sébastien Christophe LOVAL, Moissy-Cramayel (FR); Thomas GENSOUS, Moissy-Cramayel (FR)

(73) Assignee: SAFRAN AIRCRAFT ENGINES, Paris (FR)

(21) Appl. No.: 19/127,298

(22) PCT Filed: Nov. 6, 2023
(86) PCT No.: PCT/FR2023/051738

§ 371 Date: May 5, 2025

(30) Foreign Application Priority Data
Nov. 8, 2022 (FR) FR2211615

(51) Int. Cl. F16K 31/00; F01D 21/12; F16K 17/40

(52) U.S. Cl. CPC F16K 31/002; F01D 21/12; F16K 17/40; F05D 2220/323; F05D 2260/38

(57) ABSTRACT

Valve for an aircraft turbomachine, including a seat defining an air inlet, a shutter movable relative to the seat between a closed position in which the shutter at least partly closes the air inlet, and an open position in which the shutter closes the air inlet less than in the closed position, a frame fixed relative to the seat, the frame defining a housing and a recovery chamber in communication with each other, and a plug located in the housing, the plug being fusible and configured, in the solid state, to hold the shutter in a first position among the closed position and the open position, and in the molten state, flow towards the recovery chamber.

### TECHNICAL FIELD

The present disclosure relates to the field of aircraft turbomachines, and more particularly a valve for an aircraft turbomachine. Such a valve can be used to regulate ventilation in the turbomachine.

### PRIOR ART

In aircraft turbomachines, secondary air circuits are sometimes used to ensure necessary ventilation flow rates in some regions of the turbomachines. Some of these secondary air circuits may only be necessary in case of malfunction and not during nominal operation of the turbomachine. Conversely, they may be useful during nominal operation but must be shut off in case of malfunction.

In this context, the Applicant has developed an improved ventilation device for an aircraft turbomachine module, which is the object of the patent application FR 3 095 831 A1. This device comprises a closing shutter retained by a fusible locking means.

This device is entirely satisfactory in its function of regulating the secondary air circuits. However, when the locking means melts, it is discharged into the turbomachine, which is undesirable for several reasons.

The invention aims to at least partially overcome these drawbacks.

### DISCLOSURE OF THE INVENTION

For this purpose, the present disclosure relates to a valve for an aircraft turbomachine, comprising a seat defining an air inlet, a shutter movable relative to the seat between a closed position in which the shutter at least partly closes the air inlet, and an open position in which the shutter closes the air inlet less than in the closed position, a frame fixed relative to the seat, the frame defining a housing and a recovery chamber in communication with each other, and a plug located in the housing, the plug being fusible and configured, in the solid state, to hold the shutter in a first position among the closed position and the open position, and in the molten state, flow towards the recovery chamber.

When the plug melts, it flows at least partly towards the recovery chamber. In doing so, the plug frees up space in the housing and is no longer able to hold the shutter in the first position, allowing the shutter to move to the second position.

Thus, when the temperature increases in the vicinity of the plug, the shutter can automatically move to the second position, whether the open position so that the valve provides additional cooling air, or on the contrary the closed position so that the valve prevents the supply of oxygen to an incipient fire, for example.

Thanks to the fact that the valve comprises a frame defining a housing and a recovery chamber, the molten plug is recovered and does not get lost in unwanted parts of the turbomachine, which increases the reliability of the turbomachine.

In the closed position, the shutter may partially or completely close the air inlet. In the open position, the shutter may be set back from the seat, so as to close the air inlet less.

In addition to the characteristics just mentioned, the proposed method may have one or more of the following characteristics, considered separately or in technically possible combinations:
a partition separates the recovery chamber from the air inlet;
the housing protrudes away from the air inlet;
a wall of the frame is locally thinned at the housing;
the valve further comprises an elastic element configured to bias the shutter toward a second position among the closed position and the open position;
the housing is defined between the frame and the shutter;
in the second position, the shutter is housed at least partly in the housing;
in the second position, a face of the shutter opposite to the air inlet is pressed against the frame;
the shutter is movable in translation between the closed position and the open position;
the shutter is mounted between the frame and the seat;
the frame and/or the seat define an air outlet, and in the open position, the air outlet communicates with the air inlet.

The present disclosure also relates to an aircraft turbine, comprising a valve as previously described.

The aircraft turbine may comprise an annular hot air flow path and a sub-path cavity coaxial with said path, the valve being provided on a ventilation device opening out into the sub-path cavity. Moreover, the housing may connect to the sub-path cavity.

### BRIEF DESCRIPTION OF THE DRAWINGS

Other characteristics and advantages of the object of the present disclosure will emerge from the following description of embodiments, given as non-limiting examples, with reference to the appended figures.

FIG. 1 is a schematic longitudinal sectional view of a turbomachine.

FIG. 2 is a schematic partial longitudinal sectional view of a low-pressure turbine of the turbomachine of FIG. 1.

FIG. 3 is a longitudinal sectional view of a valve according to a first embodiment, in the closed position.

FIG. 4 is a front view of the valve seat according to the first embodiment, in the direction IV-IV of FIG. 3.

FIG. 5 is a longitudinal sectional view of the valve according to the first embodiment, in the open position.

FIG. 6 is a longitudinal sectional view of a valve according to a second embodiment, in the closed position.

FIG. 7 is a longitudinal half-sectional view of a valve according to a third embodiment, in the closed position.

### DETAILED DESCRIPTION

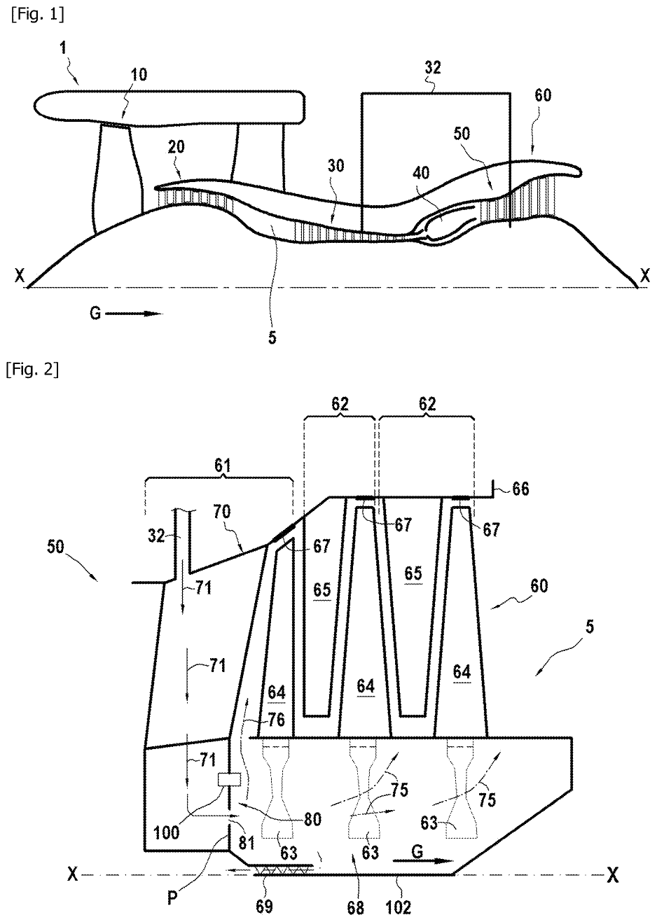

A first embodiment of the present disclosure will be presented with reference to FIGS. 1 to 5.

The terms “upstream” and “downstream” are subsequently defined relative to the direction of flow of the gases through the turbomachine, indicated by the arrow G in FIGS. 1 and 2.

FIG. 1 illustrates a turbofan turbomachine 1 comprising, in a known manner from upstream to downstream, successively at least one fan 10, an engine part successively comprising at least one low-pressure compressor stage 20, at least one high-pressure compressor stage 30, a combustion chamber 40, at least one high-pressure turbine stage 50 and at least one low-pressure turbine stage 60. In the engine part, the gases flow along an annular hot air flow path 5, in which the compressor and turbine blade assemblies extend.

Rotors, rotating about the main axis X of the turbomachine 1 and able to be coupled to each other by different transmission and gear systems, correspond to these different elements.

In a manner known per se, a fraction of air is taken from the high-pressure compressor 30 and is conveyed via a cooling air circulation duct 32 in order to cool hotter areas of the turbomachine 1, in particular the high-pressure turbine 50 and the low-pressure turbine 60.

FIG. 2 is an enlargement of an area of the turbomachine 1, illustrating in a simplified manner the upstream part of the low-pressure turbine 60, the high-pressure turbine 50 not being represented.

The low-pressure turbine 60 illustrated here comprises a plurality of turbine stages 61, 62. A first stage 61 and the stages 62 located downstream thereof respectively comprise a set of fixed nozzles 70 and 65. Each stage 61, 62 further comprises a movable disk 63 on which is mounted a set of blades 64 driven in rotation by the movable disk 63. The first stage 61 of the low-pressure turbine 60 comprises at least one blade 64, as well as at least one hollow nozzle 70, in which cooling air circulates. In the example illustrated in FIG. 2, the nozzle 70 forms a single piece with a casing 66 of the turbine and is hollow to allow cooling air to pass from the cooling duct 32. This cooling air exits via an injection device 80 associated with the nozzle 70, comprising a plurality of injectors. The following stages 62, located downstream of the low-pressure turbine 60, each comprise at least a blade 64 and a nozzle 65 in the form of a vane assembly. The movable disk 63 is secured in rotation to a low-pressure shaft 102 extending along the axis X-X, while each nozzle 65 is connected to the casing 66. Each turbine stage 61, 62 further comprises a turbine ring 67 located facing the blades 64, and which is secured to the casing 66.

The turbomachine 1 comprises a cooling device for conveying the air fraction taken from the high-pressure compressor 30 towards at least one stage of the low-pressure turbine 60. In the present embodiment, the fraction of cooling air taken is distributed at an upstream stage of the low-pressure turbine 60. The low-pressure turbine 60 is thus cooled. However, the invention is not limited to this embodiment, the air fraction taken can also be distributed to other stages of the low-pressure turbine 60 and/or to the high-pressure turbine 50.

In the embodiment illustrated in FIG. 2, the air fraction taken from the high-pressure compressor 30 flows in the cooling duct 32, then in the hollow nozzle 70. The direction of circulation of the air fraction through the hollow nozzle 70 is illustrated by the arrows 71. The air fraction is then injected via the injection device 80 into a sub-path cavity 68 coaxial with the hot air flow path 5. The distributed air makes it possible in particular to cool the disks 63 of the turbines, as illustrated by the arrows 75.

The cooling air injected by the injection device 80 moreover allows purging the hot air present in the low-pressure turbine 60, thus ensuring its cooling. More specifically, the cooling air, taken from the high-pressure compressor and conveyed to the sub-path cavity 68, constitutes a pressure barrier, or purge, preventing the hot air coming from the combustion chamber and flowing in the main air circulation path 5 of the turbines, that is to say in the primary air circulation path of the turbomachine 1, from entering the sub-path cavity 68. The purge of the hot air from the low-pressure turbine 60 is here symbolized by the arrow 76. The risks of overheating of the disks 63 of the turbines are thus limited. Particularly, by preventing the air from the path 5 from entering the sub-path cavity 68, this sub-path cavity 68 is less hot than the path 5, and the disks 63 of the turbine can therefore withstand higher centrifugal forces and be dimensioned for lower limit stresses.

In a known manner, one or more cooling air circulation ducts 32 each take a fraction of cooling air from an air stream circulating in the high-pressure compressor 30, and convey the air fraction taken at least at one stage of the low-pressure turbine 60.

A malfunction of the cooling of the turbine 60 can have several causes. One cause of the cooling malfunction can be the malfunction of a duct 32, for example the rupture or accidental closing of one of the air circulation ducts 32. Another cause of this malfunction may result from excessive wear or rupture of one or more seals, or dynamic seal of the low-pressure turbine 60. A malfunction of the cooling of the turbine 60 results for example from a failure of a labyrinth seal 69 ensuring the pressure isolation of the sub-path cavity 68 of the low-pressure turbine 60.

The injection device 80 includes a plurality of first injectors 81, and at least one, preferably several valves 100, distributed on a wall P of the nozzle 70 about the axis X. The presence of the first injectors 81 is optional, the injection device 80 may comprise only valves 100. In order to simplify the description of this embodiment, a single first injector 81 and a single valve 100 are represented in FIG. 2. Moreover, although the embodiment is described with reference to the low-pressure turbine 60, one or more valves 100 could also be provided at other locations in the turbomachine 1, such as the high-pressure turbine 50.

In any event, the valve 100 is provided on a ventilation device, here the injection device 80, opening out into the sub-path cavity 68.

The first injector 81 is an orifice made in the wall P of the nozzle 70, allowing permanently, that is to say continuously, when the turbomachine is in operation, injecting a first cooling air flow rate into the sub-path cavity 68. This first flow rate ensures the cooling, more specifically the purge 76 and the maintenance of the temperature of the low-pressure turbine 60 under its nominal operating conditions that is to say in the absence of one of the malfunctions mentioned above. The dimensions of the orifice are determined so that the first flow rate is for example comprised between 270 and 310 g/s. In some applications where the temperatures involved are lower, such cooling by a first flow rate is not necessary under nominal operating conditions. In this case, only the valves 100 are necessary.

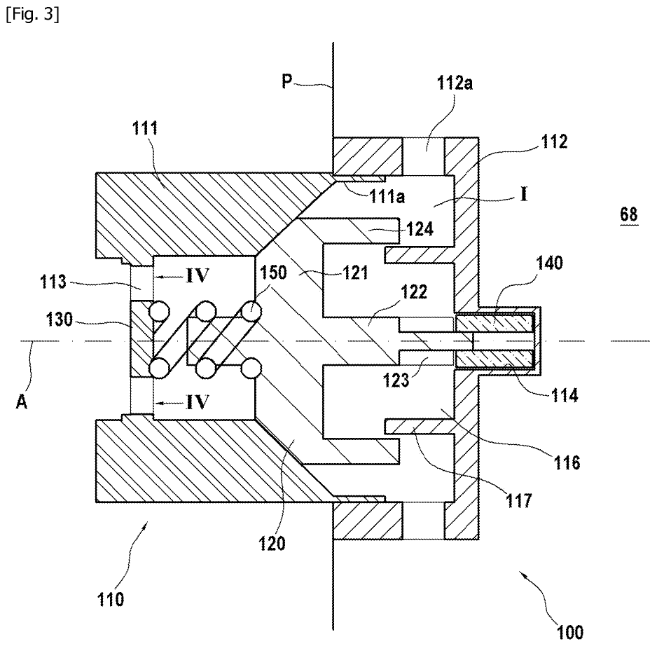

As illustrated in FIG. 3, in the first embodiment, the valve 100 comprises a fixed part 110 and a shutter 120. The fixed part 110 comprises a seat 111 and a frame 112 fixed relative to the seat 111. The seat 111 defines an air inlet 113, for example in fluid communication with the duct 32.

The seat 111 may have a cylindrical shape with axis A, a major part of which is disposed on one side of the wall P opposite to the sub-path cavity 68. However, one end 111a of the seat 111 may be inserted into an orifice in the wall P and protrude inside the sub-path cavity 68. It will be noted that the seat 111 may be fixed to the wall P, for example, by welding or brazing, typically at its end 111a. Moreover, the end 111a may be threaded.

According to one example, a portion of the frame 112, comprising a tapping, is then screwed onto the end 111a. The screw thread may be self-braking. The frame 112 is disposed on the other side of the wall P than the seat 111 that is to say in the sub-path cavity 68. The frame 112 thus has a general disk shape, seen from the front. The assembly of the seat 111 and of the frame 112 forms an inner cavity I.

The frame 112 comprises at least one air outlet 112a, preferably a plurality of air outlets 112a (two are visible in FIG. 3) distributed circumferentially about the axis A on a lateral face of the frame 112, putting the inner cavity I of the valve 100 in fluid communication with the sub-path cavity 68.

Moreover, the frame 112 defines a housing 114 and a recovery chamber 116, in fluid communication with each other. The housing 114 may protrude from the frame 112 in a direction opposite to the air inlet 113 that is to say in this case towards the sub-path cavity 68. The housing 114 therefore connects to the sub-path cavity 68. As a result, the housing 114, which receives the plug 140 described later, is more sensitive to the temperature in the sub-path cavity 68. In addition, the housing 114 is not excessively cooled by any leaks coming from the air inlet 113.

Furthermore, as illustrated, the wall of the frame 112 may be locally thinned at the housing 114. This facilitates heat conduction at the housing 114 and also contributes to making the housing 114 more sensitive to the temperature in the sub-path cavity 68.

The recovery chamber 116 is in fluid communication with the housing 114 but isolated on the one hand from the air inlet 113 and on the other hand from the air outlets 112a. In this embodiment, the recovery chamber 116 is a part of the inner cavity I which is located between the shutter 120 and the frame 112. A wall 117, here annular wall, protrudes from the frame 112 in the direction of the air inlet 113, the wall 117 forming a partition to separate the recovery chamber 116 from the air inlet 113 and, in this case, from the air outlet 112a.

The shutter 120 is movable relative to the seat 111. The shutter 120 may be disposed at least partly in the inner cavity I, between the seat 111 and the frame 112. More specifically, the shutter 120 comprises a closure member 121 disposed entirely in the inner cavity I, and a guide rod 122 extending from a downstream face of the closure member 121 and disposed partly in the housing 114, at least in the open position which will be described later. In this embodiment, the shutter 120 thus has the shape of a piston able to move by translation along the axis A.

Thus, more generally, the housing 114 is defined between the frame 112 and the shutter 120.

Moreover, the shutter 120 may comprise a guide 124. In this case, the guide 124 protrudes from the closure member 121 in the direction of the frame 112. The guide 124 may act as a guide for the shutter 120, here by cooperating with the wall 117 so as to form a slide. In this case, the guide 124 is substantially coaxial with the wall 117. The clearance between the wall 117 and the guide 124 allows taking into account the differential expansion of the shutter 120 and of the frame 112, without hindering their relative movement. Moreover, the guide 124 may define, in cooperation with the wall 117, a partition of the recovery chamber 116, in this case by an overlap between the wall 117 and the guide 124 in the direction of the axis A.

In the closed position represented in FIG. 3, the shutter 120 at least partly closes the air inlet 113. In this case, the shutter 120 is positioned along the axis A such that the closure member 121 is in contact with a wall of the seat 111. Thus, the cooling air entering through the air inlet 113 upstream of the closure member 121 that is to say to the left of the closure member 121 in FIG. 3, cannot access the part of the inner cavity I located downstream of the closure member 121, and consequently to the air outlets 112a.

The shutter 120 is held in this closed position (corresponding to a first position in this embodiment) by a plug 140 located in the housing 114. In the solid state, the plug 140 forms a spacer between the shutter 120, for example the guide rod 122, and the frame 112 so as to prevent any movement of the shutter 120 towards the frame 112.

The plug 140 is made of a fusible material, in particular fusible at some operating or malfunction temperatures of the low-pressure turbine 60. The plug 140 may be made of a eutectic material.

The plug 140 may have an annular shape, for example a hollow cylinder, to facilitate its melting.

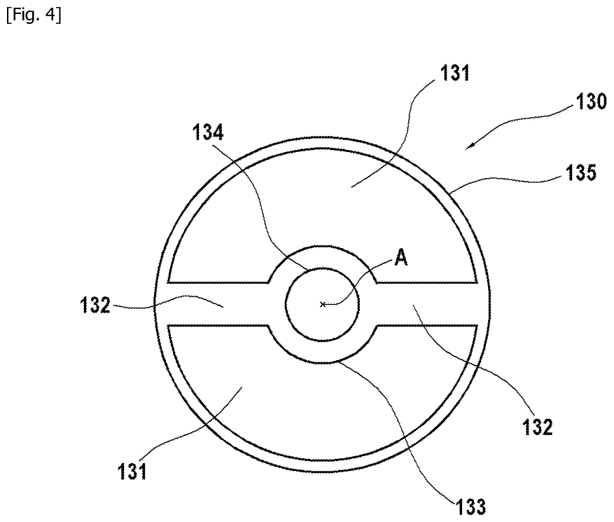

The seat 111 further comprises an upstream wall 130, fixed by welding or brazing, for example, to an inner wall of the seat 111. The upstream wall 130 is here a washer, a front view of which along the axis A is represented in FIG. 4. The washer comprises a contour 135 fixed to the inner wall of the seat 111, and a central part 133, typically circular, connected to the contour 135 by at least one arm 132, here two arms. One or more apertures 131 defining the air inlet 113 are formed between the contour 135, the arms 132 and the central part 133. The apertures 131 indeed allow the passage of the fraction 71 of the cooling air circulating in the hollow nozzle 70, to the interior of the inner cavity I of the valve 100, in the portion of said inner cavity I located upstream of the shutter 120.

An elastic element 150 such as a return spring can be disposed in the inner cavity I to return the shutter 120 to a second position, namely here an open position. In this example, the elastic element 150 is positioned upstream of the closure member 121 and mounted in compression between the central part 133 of the upstream wall 130 and the upstream face of the closure member 121. For this purpose, the central part 133 of the upstream wall 130 preferably comprises a circular groove 134, configured to receive one end of the elastic element 150 in order to hold it.

It is thus understood that the plug 140 is sufficiently incompressible to withstand the force exerted by the elastic element 150 on the shutter 120, as well as the force exerted by the pressure of the cooling air upstream of said shutter 120. In nominal operating condition, the shutter 120 is thus held in the closed position by the plug 140 in the solid state.

In case of temperature rise in the sub-path cavity 68 due to an anomaly, the plug 140 melts at least partially. The molten part of the plug 140 then flows towards the recovery chamber 116, for example through one or more slots 123 provided in the shutter 120, in this case in the guide rod 122. This flow may be facilitated by the fact that in the use configuration, the retention chamber 116 is located lower than the housing 114, so that the molten plug can flow by gravity from the housing 114 to the retention chamber 116.

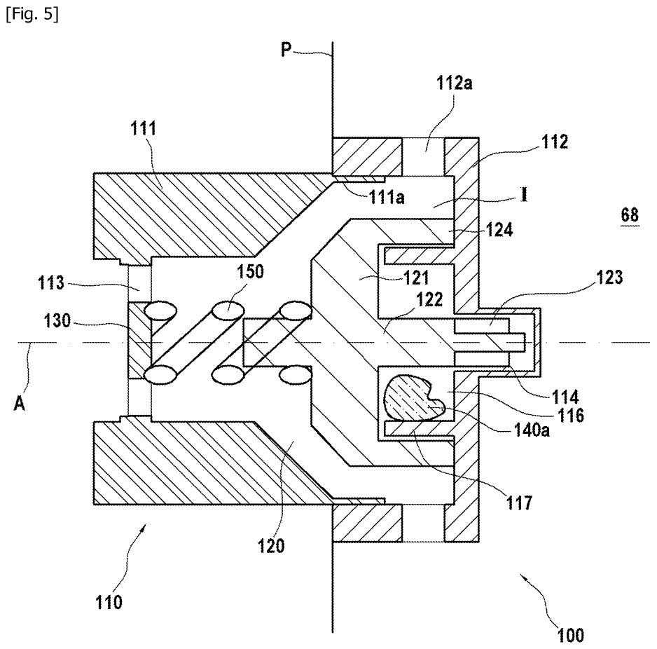

The plug 140, which has therefore partially or totally disappeared from the housing 114, therefore frees up a space that can be taken up by the shutter 120, and particularly the guide rod 112, for example under the effect of the force exerted by the elastic element 150 and/or the air pressure at the air inlet 113. The shutter 120 then moves in translation along the axis A towards the frame 112, which allows it to move to a second position, in this case an open position represented in FIG. 5, and to be held in this position.

Thus, in this second position, as shown in FIG. 5, the shutter 120 is housed at least partly in the housing 114.

In this open position, the closure member 121 is no longer in sealed contact with the seat 111, such that the upstream and downstream parts of the inner cavity I are in communication. Consequently, the cooling air initially present upstream of the closure member 121 can flow to the air outlets 112a, and thus be injected into the sub-path cavity 68. In other words, in the open position, the shutter 120 closes the air inlet 113 less than in the closed position, and moreover, the air outlets 112a communicate with the air inlet 113.

The second position can be such that a face of the shutter 120 opposite to the air inlet 113 is pressed against the frame. This prevents air from entering downstream of the shutter and risking pushing back the shutter 120 towards the air inlet 113. The shutter 120 therefore remains reliably in the second position.

Thus, when one of the malfunctions mentioned above occurs, the temperature within the sub-path cavity 68 increases and reaches values higher than the temperatures representative of a nominal operation. When the temperature within the sub-path cavity 68 reaches a threshold value for melting the plug 140, the valve 100 opens. An additional cooling air flow rate, for example comprised between 80 and 90 g/s, can then be injected into the sub-path cavity 68 via the valve 100, in addition to the first flow rate injected by the first injector 81.

The sum of the first and second flow rates is greater than the flow rate ranges representative of a nominal operation, and makes it possible to cover cases of malfunctions, characterized by an increase in the turbine temperature. Thus, it is possible to increase the cooling of the disks 63, before these elements are damaged by an excessive increase of the temperature. Particularly, the injection of the additional cooling air flow rate makes it possible to increase the purge flow rate 76, and thus to prevent the hot air of the path from entering the sub-path cavity 68.

When returning to nominal operating conditions, it is possible to reuse the valve 100, in particular by unscrewing the frame 112 and removing the shutter 120 therefrom. The molten plug 140a can be removed from the recovery chamber 116 and a new plug 140 can be placed in the housing 114. Then, the shutter 120 can be placed back in the closed position by compressing the elastic element 150.

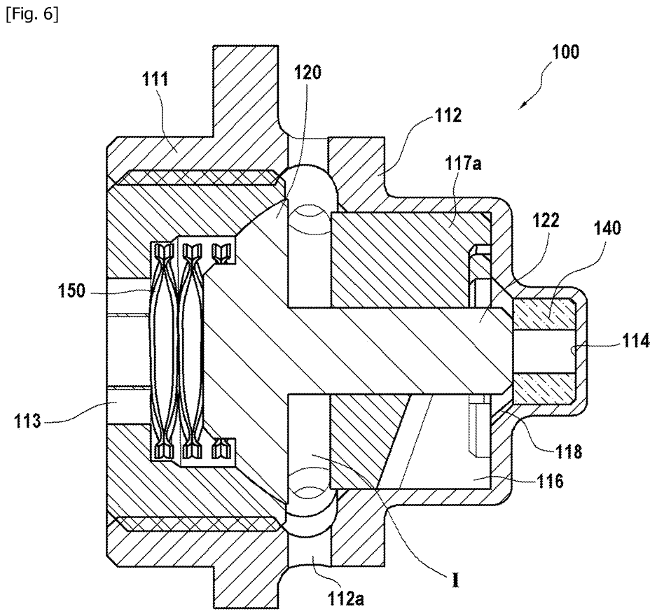

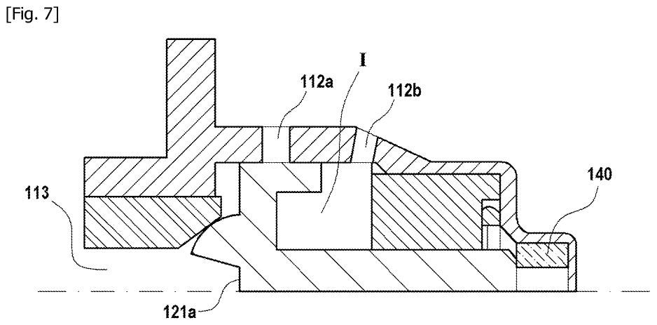

FIGS. 6 and 7 show the valve in other embodiments. In these figures, the elements corresponding or identical to those of the first embodiment will receive the same reference sign and will not be described again.

The valve 100 according to the second embodiment, illustrated in FIG. 6, is similar to that of the first embodiment. Instead of a helical spring, the elastic element 150 is here formed by a leaf spring.

Moreover, the housing 114 and the recovery chamber 116 communicate via a gutter 118 arranged in the frame 112. Thus, the guide rod 122 may be devoid of the slots 123 mentioned above. The gutter 118 may open out onto a lower wall of the housing 114, as illustrated.

Moreover, instead of the annular wall 117 described for the first embodiment, the frame of the valve 100 according to the second embodiment comprises an insert 117a. The insert 117a, housed in the remainder of the frame 112, defines a passage for the guide rod 122. The guide rod 122 engages in said passage regardless of the position of the shutter 120. This allows the housing 114 to be dimensioned independently of the guide rod 122, because the housing 114 no longer has the guiding role it had in the first embodiment.

Furthermore, the insert 117a forms a partition separating the recovery chamber 116 from the air inlet 113. In this embodiment, the recovery chamber is formed between the frame 112 and the insert 117a, for example by a recess in the lower part of the insert 117a.

Thus, the presence of a guide 124 like that of the first embodiment is not useful. As a result, the respective shapes of the shutter 120 and of the insert 117a of the frame are such that in the second position, the shutter 120 is pressed against the frame 112, here against the insert 117a.

FIG. 6 shows that the air outlets 112a can be provided in the form of transverse, here radial, ducts opening out onto the inner cavity I.

The valve 100 according to the third embodiment, illustrated in FIG. 7, is similar to that of the second embodiment. As previously indicated, it does not comprise an elastic element 150, only the pressure of the air coming from the air inlet 113 being used to move the shutter 120 to the open position. Therefore, the upstream wall 130 described previously may also be omitted.

In order to maximize the force exerted by the air coming from the air inlet 113 on the shutter 120, the upstream face of the shutter may comprise a central part 121a transverse to the direction of injection of the air by the air inlet 113. Around it, the parts of the closure member 121 configured to come into contact with the seat 111 may retain corresponding shapes, for example, in this case, substantially conical shapes.

In addition to the air outlet 112a, there is the presence of one or more vents 112b, provided on the frame 112 downstream of the air outlet 112a, in order to balance the pressures between the inner cavity I and the sub-path cavity 68. When the shutter 120 moves to the open position, this vent 112b can be closed by the shutter 120, for example part of the shutter similar to the guide 124 previously described, in order to prevent air from entering downstream of the shutter 120 through this vent 112b and risking pushing the shutter 120 towards the air inlet 113.

Although the present description refers to specific exemplary embodiments, modifications may be made to these examples without departing from the general scope of the invention. For example, as mentioned above, the first position and the second position of the shutter may be interchanged. Typically, a shutter may be held in the open position by the plug in the solid state, for example by providing for windows in a central part of the shutter for the passage of air, and in the closed position, said windows could be closed following the movement of the shutter.

More generally, individual characteristics of the various embodiments illustrated or mentioned may be combined in additional embodiments. Consequently, the description and drawings should be considered in an illustrative rather than restrictive sense.

1. A valve for an aircraft turbomachine, comprising a seat defining an air inlet, a shutter movable relative to the seat between a closed position in which the shutter at least partly closes the air inlet, and an open position in which the shutter closes the air inlet less than in the closed position, a frame fixed relative to the seat, the frame defining a housing and a recovery chamber in communication with each other, and a plug located in the housing, the plug being fusible from a solid state to a molten state and configured, in the solid state, to hold the shutter in a first position among the closed position and the open position, and in the molten state, flow towards the recovery chamber.

2. The valve according to claim 1, wherein a partition separates the recovery chamber from the air inlet.

3. The valve according to claim 1, wherein the housing protrudes away from the air inlet.

4. The valve according to claim 1, wherein a wall of the frame is locally thinned at the housing.

5. The valve according to claim 1, wherein the housing is defined between the frame and the shutter.

6. The valve according to claim 1, wherein, in a second position among the closed position and the open position, the shutter is housed at least partly in the housing.

7. The valve according to claim 1, wherein, in a second position among the closed position and the open position, a face of the shutter opposite to the air inlet is pressed against the frame.

8. The valve according to claim 1, wherein the shutter is movable in translation between the closed position and the open position.

9. The valve according to claim 1, wherein at least one of the frame and the seat defines an air outlet, and in the open position, the air outlet communicates with the air inlet.

10. An aircraft turbine comprising a valve according to claim 1.

11. The aircraft turbine according to claim 10, comprising an annular hot air flow path and a sub-path cavity coaxial with said path, the valve being provided on a ventilation device opening out into the sub-path cavity, the housing connecting to the sub-path cavity.

12. The valve according to claim 1, wherein the shutter is mounted between the frame and the seat.
